(19) United States
(12) Patent Application Publication
(10) Pub. No.: US 2025/0283765 A1
(43) Pub. Date: Sep. 11, 2025

(54) Force Sensitive Sensing

(71) Applicant: Cox Automotive, Inc., Atlanta, GA (US)

(72) Inventors: Connor Taylor, Atlanta, GA (US); Sarah Hake, Atlanta, GA (US)

(21) Appl. No.: 19/075,139

(22) Filed: Mar. 10, 2025

Related U.S. Application Data
(60) Provisional application No. 63/562,937, filed on Mar. 8, 2024.

(51) Int. Cl. G01K 7/10; G01L 1/20; H01M 10/42; H01M 10/48

(52) U.S. Cl. CPC G01K 7/10; G01L 1/20; H01M 10/4207; H01M 10/486

(57) ABSTRACT

An example force-sensitive measuring device includes: a main body having a proximal end and a distal end; a frame coupled to the main body at the proximal end; a spring coupled between the main body and the frame; a sensor coupled to the main body; and a position sensor coupled to the proximal end of the main body, where, when the sensor touches a surface, the spring is compressed and the position sensor detects that the distal end of the main body is touching the surface.

### CROSS-REFERENCE TO RELATED APPLICATIONS

This application claims the benefit of U.S. provisional patent application No. 63/562,937, filed on Mar. 8, 2024, and titled “Force Sensitive Sensing” the disclosure of which is expressly incorporated herein by reference in its entirety.

### BACKGROUND

Sensors are commonly used in both testing and routine operation of various systems. Many types of sensors are configured to sense conditions that are near to, or directly contacting the sensor. Such sensors can be considered “on site” or “in situ.” When sensors are deployed in a system, the sensors can be configured to measure a known location in the system and collect data from that point. The data can then be used to assess whether the system is operating correctly, quantitatively characterize the operation of the system, or for any other purpose.

There are benefits to improving sensors and devices for using sensors in systems.

### SUMMARY

In some aspects, implementations of the present disclosure relate to a force-sensitive measuring device including: a main body having a proximal end and a distal end; a frame coupled to the main body at the proximal end; a spring coupled between the main body and the frame; a sensor coupled to the main body; and a position sensor coupled to the proximal end of the main body, whereby when the sensor touches a surface, the spring is compressed and the position sensor detects that the distal end of the main body is touching the surface.

In some aspects, implementations of the present disclosure relate to a force-sensitive measuring device, wherein the sensor is thermocouple and/or thermistor.

In some aspects, implementations of the present disclosure relate to a force-sensitive measuring device, wherein the spring includes a multi-wave compression spring.

In some aspects, implementations of the present disclosure relate to a force-sensitive measuring device, wherein the main body includes a channel extending between the proximal end and the distal end, and wherein the sensor is disposed in the channel.

In some aspects, implementations of the present disclosure relate to a force-sensitive measuring device, wherein the main body includes a bolt with a bolt head formed on the proximal end of the main body.

In some aspects, implementations of the present disclosure relate to a force-sensitive measuring device, wherein the sensor includes a printed circuit board formed between the bolt head and the frame.

In some aspects, implementations of the present disclosure relate to a force-sensitive measuring device, wherein the position sensor includes a force-sensitive resistor.

In some aspects, implementations of the present disclosure relate to a force-sensitive measuring device, wherein the force-sensitive resistor is coupled between the spring and the frame.

In some aspects, implementations of the present disclosure relate to a force-sensitive measuring device, wherein the main body includes a threaded portion formed on at least a part of a surface extending between the proximal and the distal end.

In some aspects, implementations of the present disclosure relate to a system for force-sensitive temperature measurement, the system including: an actuator; a frame coupled to the actuator; a controller operably coupled to the actuator, wherein the controller is configured to move the actuator between a deployed position and a retracted position; and a plurality of force-sensitive measuring devices coupled to the frame, wherein each of the plurality of force-sensitive measuring devices includes: a main body having a proximal end and a distal end; a spring coupled between the main body and the frame; a sensor coupled to the main body; and a position sensor coupled to the proximal end of the main body, whereby when the sensor touches a surface, the spring is compressed and the position sensor detects that the distal end of the main body is touching the surface.

In some aspects, implementations of the present disclosure relate to a system for force-sensitive temperature measurement, wherein the sensor is thermocouple and/or thermistor.

In some aspects, implementations of the present disclosure relate to a system for force-sensitive temperature measurement, wherein the spring includes a multi-wave compression spring.

In some aspects, implementations of the present disclosure relate to a system for force-sensitive temperature measurement, wherein the main body includes a channel extending between the proximal end and the distal end, and wherein the sensor is disposed in the channel.

In some aspects, implementations of the present disclosure relate to a system for force-sensitive temperature measurement, wherein the main body includes a bolt with a bolt head formed on the proximal end of the main body.

In some aspects, implementations of the present disclosure relate to a system for force-sensitive temperature measurement, wherein the sensor includes a printed circuit board formed between the bolt head and the frame.

In some aspects, implementations of the present disclosure relate to a system for force-sensitive temperature measurement, wherein the position sensor includes a force-sensitive resistor.

In some aspects, implementations of the present disclosure relate to a system for force-sensitive temperature measurement, wherein the force-sensitive resistor is coupled between the spring and the frame.

In some aspects, implementations of the present disclosure relate to a system for force-sensitive temperature measurement, wherein the main body includes a threaded portion formed on at least a part of a surface extending between the proximal and the distal end.

In some aspects, implementations of the present disclosure relate to a method of making a force-sensitive measuring device, the method including: providing a bolt with a proximal end and a distal end, wherein a bolt head is formed on the proximal end, and a threaded portion including bolt threads extends along a surface of the bolt between the proximal end and the distal end; removing at least a portion of the bolt threads from the bolt to form a smooth section along at least a portion of the surface of the bolt; positioning a printed circuit board adjacent to the head of the bolt, the printed circuit board having an electrical contact; inserting the bolt through a hole formed in a frame; coupling a spring between the bolt and the frame; attaching a nut to the threaded portion of the bolt so that the nut couples the spring, frame, and printed circuit board together; and inserting a sensor through a channel in the bolt towards the distal end of the bolt.

In some aspects, implementations of the present disclosure relate to a method, wherein the channel in the bolt is formed by boring a channel between the proximal end of the bolt and the distal end of the bolt.

### BRIEF DESCRIPTION OF DRAWINGS

FIG. 1A illustrates an example force-sensitive measuring device including an electrical contact and spring, where the spring is uncompressed, according to implementations of the present disclosure.

FIG. 1B illustrates the example force-sensitive measuring device of FIG. 1A where the spring is compressed, according to implementations of the present disclosure.

FIG. 2A illustrates an example force-sensitive measuring device including a force-sensitive resistor and a spring, where the spring is uncompressed, according to implementations of the present disclosure.

FIG. 2B illustrates the example force-sensitive measuring device of FIG. 2A where the spring is compressed, according to implementations of the present disclosure.

FIG. 3 illustrates an example battery pack including thermowells, according to implementations of the present disclosure.

FIG. 4 illustrates an example system including multiple force-sensitive measuring devices, according to implementations of the present disclosure.

FIG. 5 illustrates a section view of a proximal end of a force-sensitive measuring device with an electrical contact and spring, where the spring is uncompressed, according to implementations of the present disclosure.

FIG. 6 illustrates an example cross section of a thermowell being measured by an example force-sensitive measuring device, according to implementations of the present disclosure.

FIG. 7 illustrates an example force-sensitive measuring device, according to implementations of the present disclosure.

FIG. 8 illustrates a perspective view of the force-sensitive measuring device including a contact sensor, according to implementations of the present disclosure.

FIG. 9 illustrates an example method of making a force-sensitive measuring device, according to implementations of the present disclosure.

FIG. 10 illustrates an example computing device.

### DETAILED DESCRIPTION

In-situ sensing can require positioning a sensor so that it is adjacent to, or contacting, a location of interest (e.g., what the sensor is sensing). For example, thermistors and thermocouples are mechanical devices that measure temperature by the change in temperature of the devices themselves. A thermocouple includes two dissimilar metals where a voltage is created across the thermocouple by the Seebeck effect when the dissimilar metals are heated. Likewise, a thermistor experiences a change in resistance when the temperature of the thermistor changes. Thus, thermocouples and thermistors experience the temperature change that they are sensing. Other sensors measuring other physical and chemical phenomena likewise are positioned in situ to sense what the sensor is adjacent to or contacting. As some non-limiting examples, temperature sensors, acid-base sensors, moisture sensors, flow sensors, vibration sensors, and/or chemical sensors, all can require that the sensor be disposed close to the subject that is sensed by the sensor. While various sensors can benefit from being placed in-situ, placing sensors in situ can risk damage to the sensor or to an object being sensed. The present disclosure includes systems, devices, and methods for force-sensitive measurement, where the example systems, devices, and methods can position sensors to contact or be adjacent to a subject (e.g., the surface of the subject), while limiting the force applied to a location being sensed (e.g., to prevent damage).

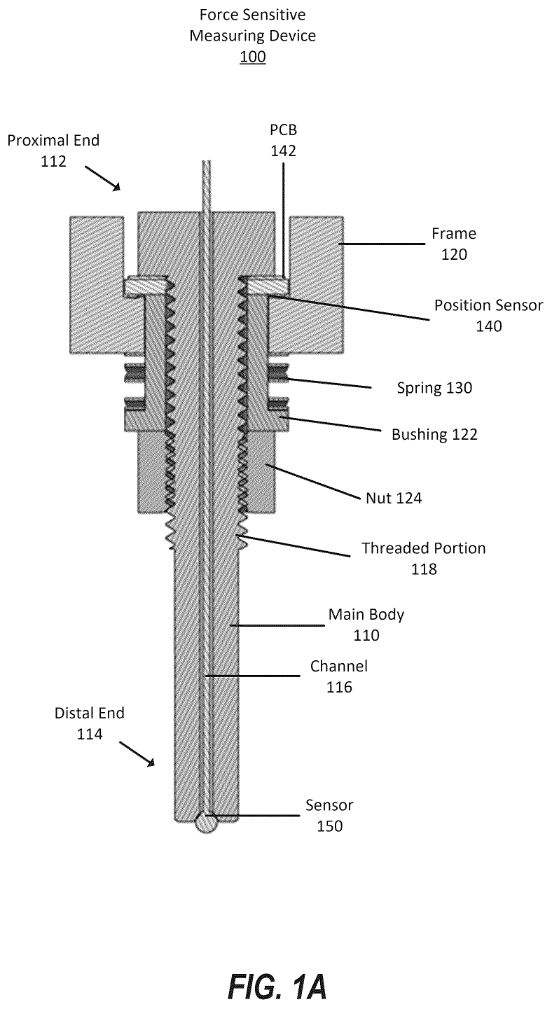

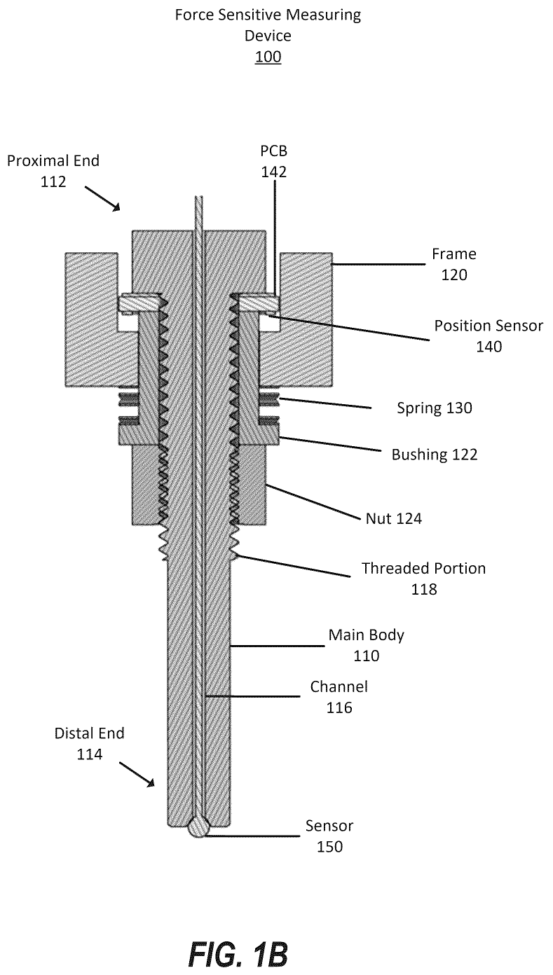

With reference to FIGS. 1A and 1B, implementations of the present disclosure include a force-sensitive measuring device 100. The force-sensitive measuring device 100 includes a main body 110. The main body 110 includes a proximal end 112 and a distal end 114.

Optionally, the proximal end 112 of the main body 110 can be configured to attach to a frame 120. The frame 120 can be configured to attach to any number of force-sensitive measuring devices 100. As shown in FIGS. 1A and 1B, the main body 110 can optionally include a bushing 122 between the main body 110 and the frame 120.

Still with reference to FIGS. 1A and 1B, the force-sensitive measuring device 100 can include a spring 130. The spring 130 can be disposed between the frame 120 and the main body 110, so that a force applied to the main body 110 can cause the spring 130 to be compressed or extended from the resting length of the spring 130. As shown in FIGS. 1A and 1B, the bushing 122 can be used to attach the spring 130 to the main body 110. Optionally, the spring 130 can be a helical wave spring including flat wire windings, but implementations of the present disclosure can include any type of spring, including coil springs, multi-wave compression springs, leaf springs, and other wave springs. In some implementations the spring 130 can be a section of elastic material or compressible material.

In some implementations of the present disclosure, the main body 110 can be formed from a bolt and/or using a bolt. For example, the proximal end 112 of the main body 110 can be shaped as a bolt head, and a threaded portion 118 can be disposed over any portion of the main body 110 between the proximal end 112 and distal end 114 of the main body 110. Optionally, a nut 124 can be attached to the threaded portion 118 and configured to couple a spring 130 between the frame 120 and the main body 110, as shown in FIG. 1A and FIG. 1B.

The force-sensitive measurement device 100 can include a position sensor 140 that detects the movement of the main body 110 relative to the frame 120. For example, a force can be applied to the distal end 114 of the main body toward the frame 120, causing the spring 130 to be compressed. The position sensor 140 can optionally be configured to measure the amount of compression of the spring 130, movement of the spring 130, or a force exerted by the spring 130.

As used herein, a position sensor can refer to sensors that detect or measure force or movement of the main body 110. The position sensor 140 can be any type of force or contact sensor, including various types of load cells (pneumatic, piezoelectric capacitive, inductive, magnetostrictive), strain gauge(s), electrical contacts, force-sensitive resistors etc. In the implementation of a force-sensitive measurement device 100 of FIGS. 1A and 1B, the position sensor 140 is an electrical contact. The position sensor 140 can further include a Printed Circuit Board (PCB) 142. Optionally, the PCB 142 can be a square PCB that is configured to be disposed in the frame 120, as shown in FIGS. 1A and 1B. If the proximal end 112 of the main body 110 is shaped as a bolt head, the PCB 142 can be configured to be attached to the main body 110 by the bolt head and bushing 122. The position sensor 140 can form a closed circuit to the frame 120 when the spring 130 is in an extended and/or relaxed state, as shown in FIG. 1B. When a force is applied compressing the spring 130, the position sensor and PCB are lifted off the frame 120 as shown in FIG. 1A. Lifting the position sensor 140 off the frame 120 creates an open circuit with the contact of the position sensor 140, indicating that force is being applied to the main body 110.

The distal end 114 of the main body 110 can include a sensor 150. The main body 110 can be sized and shaped to position the sensor 150 adjacent to or contacting an area that the sensor 150 is configured to sense. In some implementations, the sensor 150 is a thermocouple and/or thermistor configured to measure the temperature of a surface adjacent to the distal end 114 of the main body 110.

Optionally, the main body 110 can be formed from a material selected to improve the performance of the sensor 150. For example, if the sensor 150 is a temperature sensor, the main body can be formed from a temperature insulating material that limits the absorption of heat by the main body 110 to improve the accuracy of temperature measurement from the sensor 150. In some implementations, the main body 110 is formed from a synthetic polymer (e.g., a nylon bolt or shaft) that insulates the sensor 150 to improve the accuracy of the temperature reading.

Optionally, as shown in FIG. 1A and FIG. 1B, the main body 110 can include a channel 116 formed between the proximal end 112 and distal end 114 of the main body 110. The channel can be configured to receive the sensor 150 and/or any electrical connections with the sensor 150 (e.g., wires).

In some implementations of the present disclosure, the position sensor 140 can be used to determine when the sensor 150 contacts a surface being measured, and/or to prevent the main body and/or sensor 150 from applying excessive force to the surface being measured. For example, the spring 130 can be sized so that the amount of force required to cause a movement of the main body 110 relative to the frame 120 is small enough that a surface or subject being sensed is not damaged. Implementations of the force-sensitive measuring device described herein can therefore provide a sensor that can be deployed to different lengths depending on where the surface being sensed is relative to the frame. Optionally, this can benefit sensing systems where the tolerances and configurations of parts are such that the exact location of a surface being sensed is not certain.

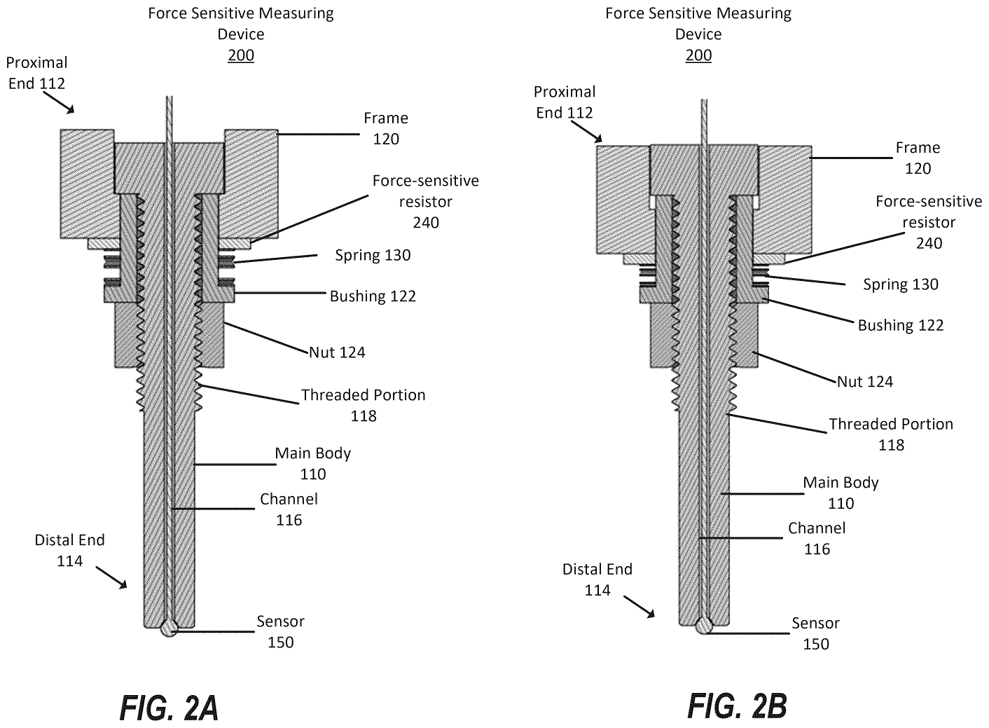

With reference to FIGS. 2A and 2B, implementations of the present disclosure include force-sensitive measuring devices 200 including a force-sensitive resistor 240 as a position sensor. The force-sensitive measuring device shown in FIGS. 2A and 2B includes the frame 120, spring 130, bushing 122, nut 124, main body 110, channel 116, and sensor 150 shown and described in FIGS. 1A and 1B. The force-sensitive resistor 240 can be disposed between the spring 130 and the frame 120 so that a force applied to the distal end 114 of the main body 110 is transmitted through the spring 130 and to the force-sensitive resistor 240. By measuring the resistance of the force-sensitive resistor 240, the amount of force on the main body 110 can be measured/detected, allowing a detection that the force-sensitive measuring device 200 is contacting a surface with the sensor 150 located at the distal end 114 of the main body 110.

FIG. 2A illustrates the force sensitive measuring device 200 where a force is not applied to the distal end 114 in the direction of the proximal end 112. The spring 130 is in a relaxed state. In the relaxed state, the spring 130 can apply some force to the force-sensitive resistor 240. FIG. 2B illustrates the force sensitive measuring device 200 when a force is applied to the distal end 114 in the direction of the proximal end 112. As shown in FIG. 2B, the spring 130 compresses in response to force being applied to the distal end 114 towards the proximal end 112, increasing the force on the force-sensitive resistor 240 relative to the force on the force sensitive resistor 240 when the spring 130 is in a relaxed state.

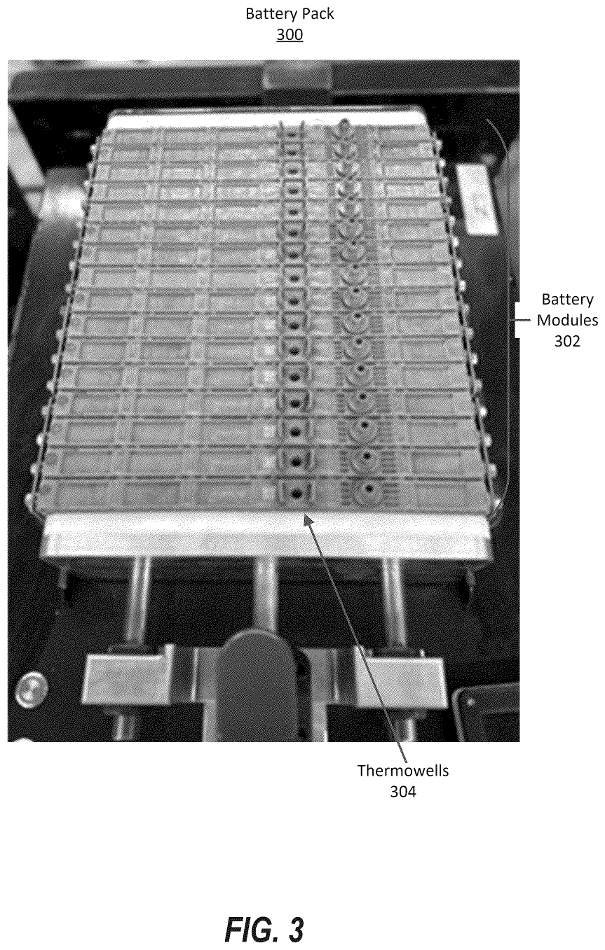

With reference to FIG. 3, an example battery pack 300 is illustrated that can be measured using the force-sensitive measuring devices 100, 200 shown in FIGS. 1A-2B. The battery pack 300 includes one or more battery modules 302. A row of thermowells 304 runs along the battery pack, where each battery includes one thermowell. As used herein, a “thermowell” refers to a structure that is configured to allow a probe to measure a temperature from a location near the center of the battery (or other subject), without the probe being located inside the battery module (or other subject). As described with reference to FIGS. 1A-2B, the main body 110 of the force-sensitive measuring device 100, 200 can optionally include a temperature sensor (e.g., a thermocouple or thermistor). The main body 110 of one or more force-sensitive measuring devices 100, 200 can be inserted into the thermowells 304 of the one or more battery modules 302 to measure the temperature of the battery modules 302. Because the force-sensitive measuring devices 100, 200 include springs that allow the main body to move relative to the frame, the force-sensitive measuring device 100, 200 can detect when a surface of the thermowells is touched and also prevent excessive force from being applied to the thermowell. This allows the sensor 150 to be positioned accurately inside the battery module 302 and/avoids damaging the battery module 302. It should be understood that the battery pack 300 is a non-limiting example of a structure that can be measured using implementations of the present disclosure, and that various implementations of the present disclosure can be used for any application, and can include any type of sensors, as described with reference to FIGS. 1A-2B.

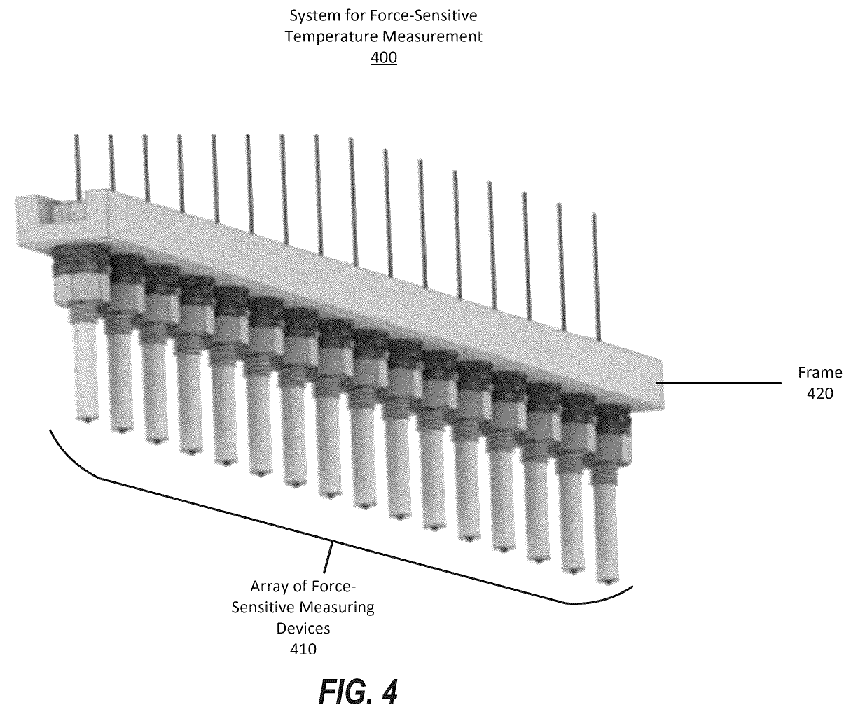

With reference to FIG. 4, implementations of the present disclosure can include systems for force-sensitive measurement 400, including an array 410 of force-sensitive measuring devices (e.g., the force-sensitive measuring devices 100, 200 described with reference to FIGS. 1A-2B) attached to a common frame 420. The array 410 and frame 420 can be sized so that the array 410 fits within a set of thermowells (e.g., the thermowells 304, shown in FIG. 3).

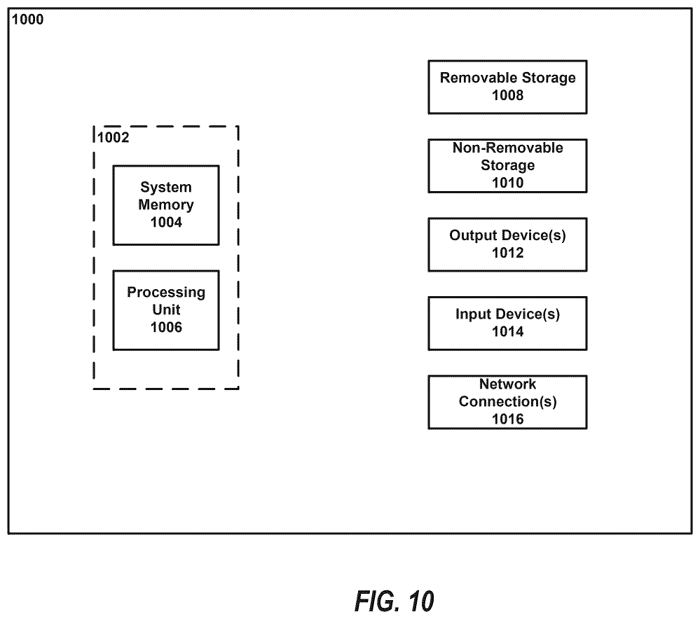

Optionally, implementations of the present disclosure can include an actuator (not shown) configured to move the array 410, and/or a controller configured to move the actuator. Optionally, the controller can be configured to receive measurements from the position sensors and/or sensors of the one or more force-sensitive measuring devices. Optionally, the movement of the actuator is based on measurements from one or more positions sensors of the force-sensitive measuring devices. For example, the controller can be configured to cause the actuator to lower the array 410 into thermowells, and stop lowering the array when a condition is met (e.g., one or more position sensors of the force-sensitive measuring devices detects contact with a surface). Optionally, the controller can include any or all of the components of the computing device 1000 shown in FIG. 10.

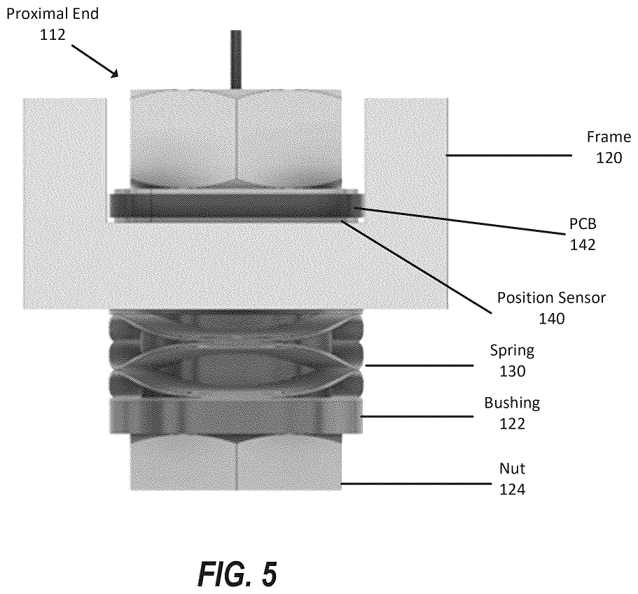

With reference to FIG. 5, a sectional view is shown of a proximal end 112 of an example implementation of a force-sensitive measuring device, such as the measuring devices 100, 200 of FIG. 1A-2B. The sectional view illustrates a coupling between the frame 120, PCB 142, position sensor 140, spring 130, bushing 122, and nut 124, described with reference to FIGS. 1A-1B.

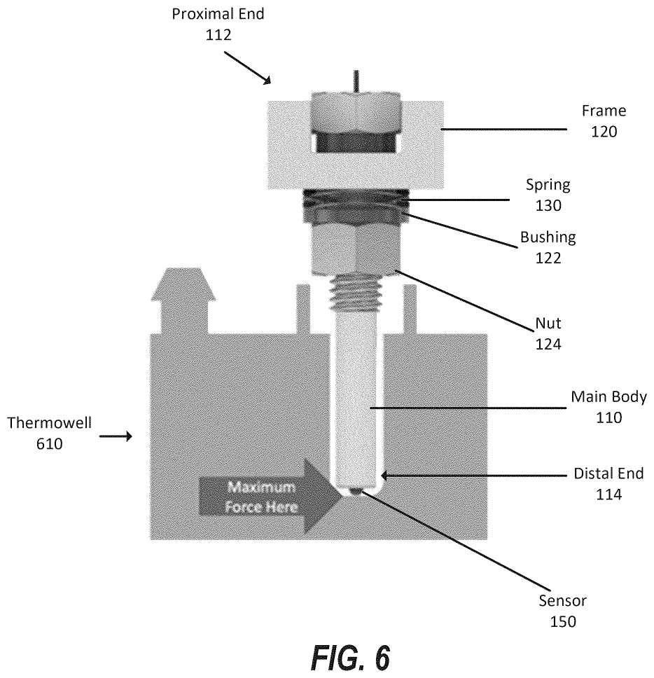

With reference to FIG. 6, implementations of the present disclosure can optionally be configured for force-sensitive measurements without using the position sensor 140 or force-sensitive resistor 240 described with reference to FIGS. 1A-2B. FIG. 6 illustrates a thermowell 610 that the sensor 150 is configured to measure the temperature of. The spring 130 prevents the distal end 114 of the main body from applying excessive force to the thermowell 610, and thereby can prevent damage to the thermowell 610, while also ensuring that the sensor 150 contacts the thermowell 610.

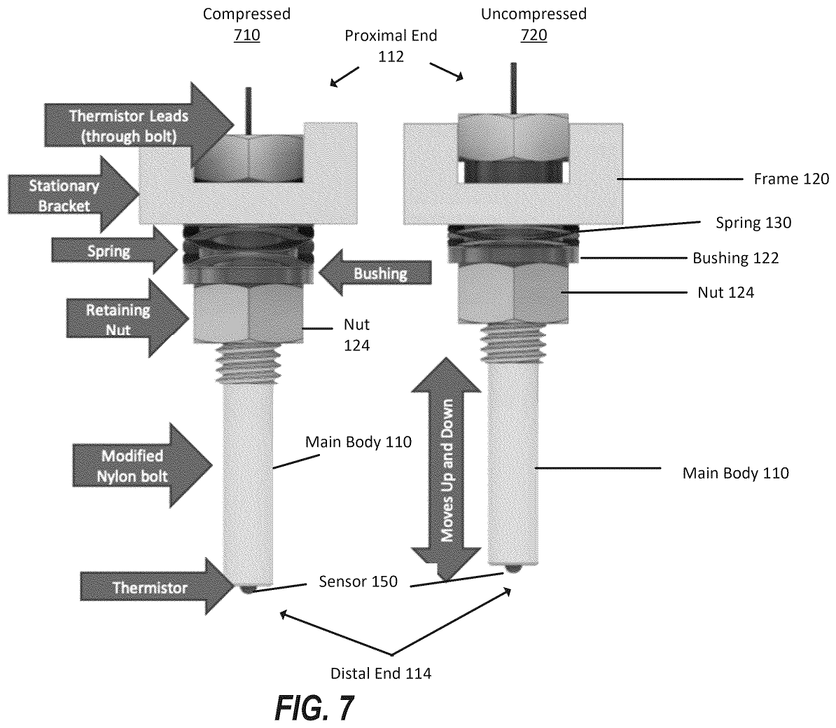

FIG. 7 illustrates the example implementation shown in FIG. 6 in an uncompressed position 710 and a compressed position 720.

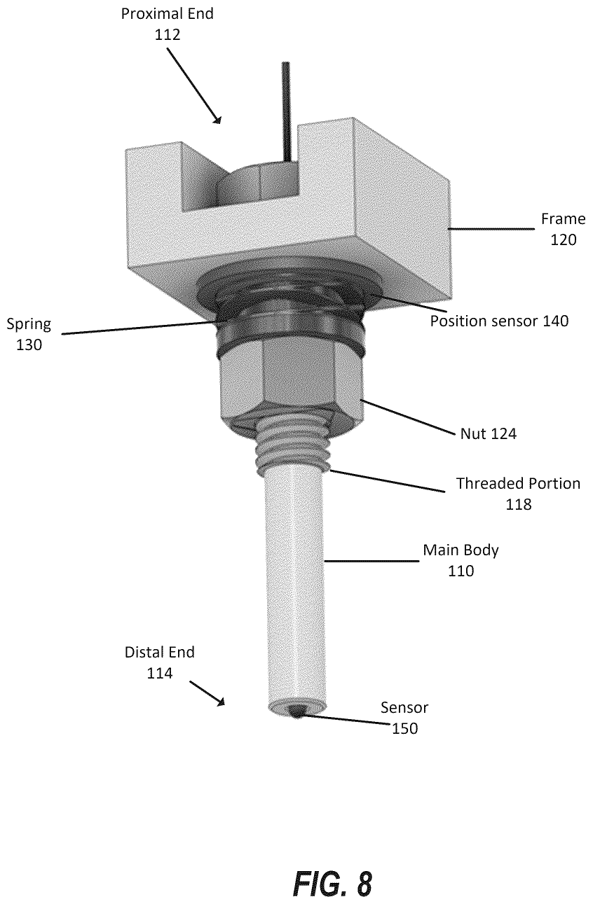

FIG. 8 illustrates a perspective view of an example implementation of the present disclosure including a position sensor 140 positioned between the spring 130 and frame 120.

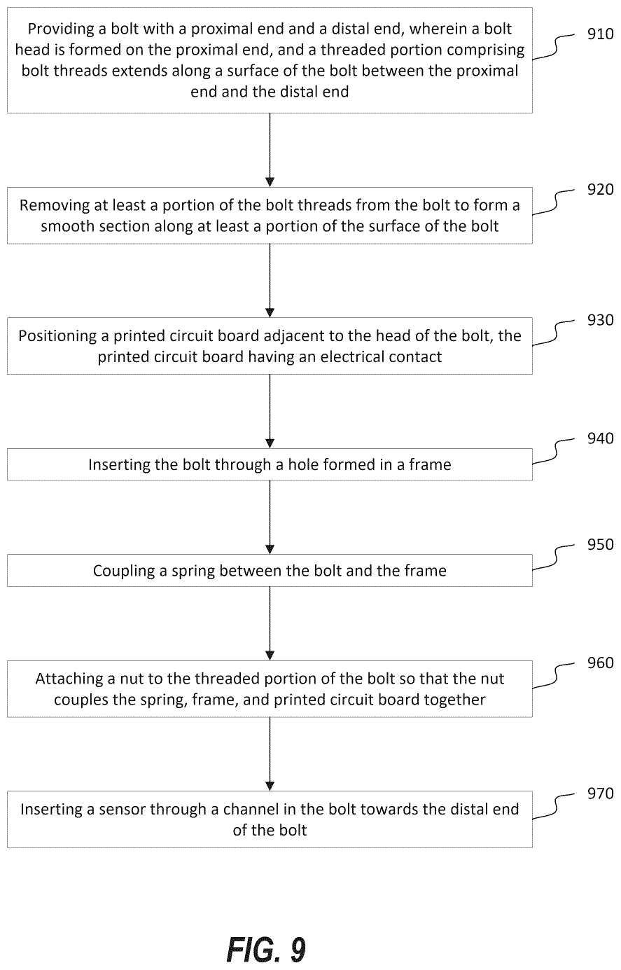

With reference to FIG. 9, implementations of the present disclosure include methods of making force-sensitive measuring devices.

At step 910, the method includes providing a bolt with a proximal end and a distal end, where a bolt head is formed on the proximal end, and a threaded portion comprising bolt threads extends along a surface of the bolt between the proximal end and the distal end. FIGS. 1A-2B illustrate an example main body 110 that can optionally be formed as a bolt.

At step 920 the method includes removing at least a portion of the bolt threads from the bolt to form a smooth section along at least a portion of the surface of the bolt. For example, the bolt may include threads along the whole surface between the proximal and distal end of the bolt, and the method can include removing unnecessary threads toward the distal end of the bolt. As shown in FIG. 1A-2B, the main body 110 includes a threaded portion 118 that terminates before the distal end 114 of the main body 110.

At step 930, the method includes positioning a printed circuit board adjacent to the head of the bolt, the printed circuit board having an electrical contact. FIGS. 1A-1B illustrate an example PCB 142 and position sensor 140 with an electrical contact.

At step 940, the method includes inserting the bolt through a hole formed in a frame. As shown in the cross-sectional view in FIGS. 1A-2B, the main body 110 passes through the frame 120.

At step 950, the method includes coupling a spring between the bolt and the frame. As described with reference to FIGS. 1A-2B, the spring can be any kind of spring, and can optionally be coupled between the frame and the main body using a bushing 122 as shown in FIGS. 1A-2B.

At step 960, the method includes attaching a nut to the threaded portion of the bolt so that the nut couples the spring, frame, and printed circuit board together. FIGS. 1A-1B illustrate a nut 124 that couples the PCB 142 to the main body 110.

At step 970, the method includes inserting a sensor through a channel in the bolt towards the distal end of the bolt. As shown in FIGS. 1A-2B, the main body 110 can include a channel between the proximal end 112 and distal end 114. In some implementations, the method can further include boring a channel between the proximal end of the bolt and the distal end of the bolt.

Referring to FIG. 10, an example computing device 1000 upon which the methods described herein may be implemented is illustrated. It should be understood that the example computing device 1000 is only one example of a suitable computing environment upon which the methods described herein may be implemented. Optionally, the computing device 1000 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1000 typically includes at least one processing unit 1006 and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 3 by dashed line 1002. The processing unit 1006 may be a standard programmable processor that performs arithmetic and logic operations necessary for operation of the computing device 1000. The computing device 1000 may also include a bus or other communication mechanism for communicating information among various components of the computing device 1000.

Computing device 1000 may have additional features/functionality. For example, computing device 1000 may include additional storage such as removable storage 1008 and non-removable storage 1010 including, but not limited to, magnetic or optical disks or tapes. Computing device 1000 may also contain network connection(s) 1016 that allow the device to communicate with other devices. Computing device 1000 may also have input device(s) 1014 such as a keyboard, mouse, touch screen, etc. Output device(s) 1012 such as a display, speakers, printer, etc. may also be included. The additional devices may be connected to the bus in order to facilitate communication of data among the components of the computing device 1000. All these devices are well known in the art and need not be discussed at length here.

The processing unit 1006 may be configured to execute program code encoded in tangible, computer-readable media. Tangible, computer-readable media refers to any media that is capable of providing data that causes the computing device 1000 (i.e., a machine) to operate in a particular fashion. Various computer-readable media may be utilized to provide instructions to the processing unit 1006 for execution. Example tangible, computer-readable media may include, but is not limited to, volatile media, non-volatile media, removable media and non-removable media implemented in any method or technology for storage of information such as computer readable instructions, data structures, program modules or other data. System memory 1004, removable storage 1008, and non-removable storage 1010 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

1. A force-sensitive measuring device comprising:
a main body having a proximal end and a distal end;
a frame coupled to the main body at the proximal end;
a spring coupled between the main body and the frame;
a sensor coupled to the main body; and
a position sensor coupled to the proximal end of the main body, whereby when the sensor touches a surface, the spring is compressed and the position sensor detects that the distal end of the main body is touching the surface.

2. The force-sensitive measuring device of claim 1, wherein the sensor is thermocouple.

3. The force-sensitive measuring device of claim 1, wherein the spring comprises a multi-wave compression spring.

4. The force-sensitive measuring device of claim 1, wherein the main body comprises a channel extending between the proximal end and the distal end, and wherein the sensor is disposed in the channel.

5. The force-sensitive measuring device of claim 1, wherein the main body comprises a bolt with a bolt head formed on the proximal end of the main body.

6. The force-sensitive measuring device of claim 5, wherein the sensor comprises a printed circuit board formed between the bolt head and the frame.

7. The force-sensitive measuring device of claim 1, wherein the position sensor comprises a force-sensitive resistor.

8. The force-sensitive measuring device of claim 7, wherein the force-sensitive resistor is coupled between the spring and the frame.

9. The force-sensitive measuring device of claim 1, wherein the main body comprises a threaded portion formed on at least a part of a surface extending between the proximal and the distal end.

10. A system for force-sensitive temperature measurement, the system comprising:
an actuator;
a frame coupled to the actuator;
a controller operably coupled to the actuator, wherein the controller is configured to move the actuator between a deployed position and a retracted position; and
a plurality of force-sensitive measuring devices coupled to the frame, wherein each of the plurality of force-sensitive measuring devices comprises:
a main body having a proximal end and a distal end;
a spring coupled between the main body and the frame;
a sensor coupled to the main body; and
a position sensor coupled to the proximal end of the main body, whereby when the sensor touches a surface, the spring is compressed and the position sensor detects that the distal end of the main body is touching the surface.

11. The system for force-sensitive temperature measurement of claim 10, wherein the sensor is a thermocouple.

12. The system for force-sensitive temperature measurement of claim 10, wherein the spring comprises a multi-wave compression spring.

13. The system for force-sensitive temperature measurement of claim 10, wherein the main body comprises a channel extending between the proximal end and the distal end, and wherein the sensor is disposed in the channel.

14. The system for force-sensitive temperature measurement of claim 10, wherein the main body comprises a bolt with a bolt head formed on the proximal end of the main body.

15. The system for force-sensitive temperature measurement of claim 14, wherein the sensor comprises a printed circuit board formed between the bolt head and the frame.

16. The system for force-sensitive temperature measurement of claim 10, wherein the position sensor comprises a force-sensitive resistor.

17. The system for force-sensitive temperature measurement of claim 16, wherein the force-sensitive resistor is coupled between the spring and the frame.

18. The system for force-sensitive temperature measurement of claim 10, wherein the main body comprises a threaded portion formed on at least a part of a surface extending between the proximal and the distal end.

19. A method of making a force-sensitive measuring device, the method comprising:
providing a bolt with a proximal end and a distal end, wherein a bolt head is formed on the proximal end, and a threaded portion comprising bolt threads extends along a surface of the bolt between the proximal end and the distal end;
removing at least a portion of the bolt threads from the bolt to form a smooth section along at least a portion of the surface of the bolt;
positioning a printed circuit board adjacent to the head of the bolt, the printed circuit board having an electrical contact;
inserting the bolt through a hole formed in a frame;
coupling a spring between the bolt and the frame;
attaching a nut to the threaded portion of the bolt so that the nut couples the spring, frame, and printed circuit board together; and
inserting a sensor through a channel in the bolt towards the distal end of the bolt.

20. The method of claim 19, wherein the channel in the bolt is formed by boring a channel between the proximal end of the bolt and the distal end of the bolt.
